(19) United States
(12) Patent Application Publication
(10) Pub. No.: US 2009/0079646 A1
(43) Pub. Date: Mar. 26, 2009

(54) RADIO FREQUENCY DEVICE FOR UNMIXING POLARIZED SIGNALS AND ASSOCIATED METHODS

(75) Inventor: Arthur S. OLSEN, Melbourne, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 11/859,137

(22) Filed: Sep. 21, 2007

(51) Int. Cl. H01Q 19/00

(52) U.S. Cl. 343/756

(57) ABSTRACT

A radio frequency (RF) device includes an antenna array for receiving dual polarized RF signals, and in-phase and quadrature modules coupled to the antenna array for generating in-phase and quadrature components. A homology group matched filter is coupled to the in-phase and quadrature modules for determining an unmixing equation for generating unmixed dual polarized RF signals, and for applying at least one estimated source polarization homology parameter to the unmixing equation. An unmixed dual polarized RF signal level is generated by the homology group matched filter based upon the at least one estimated source polarization homology parameter and the unmixed dual polarized RF signals. A threshold detector is coupled to the homology grouped matched filter for determining if the unmixed dual polarized RF signal level is above a threshold.

### FIELD OF THE INVENTION

The present invention relates to the field of signal processing, and more particularly, to unmixing elliptically polarized source signals.

### BACKGROUND OF THE INVENTION

A common approach for unmixing polarized signals collected from polarization diverse arrays is known as the long-vector method. In the long-vector method, filtering is performed in a vector space formed from the components of individual polarization elements. Vector spaces are not closed under multiplication, and hence do not form an algebra. Instead, the inner product is used to project into signal subspaces.

However, the inner product only examines auto-term polarization component products between vector components and does not include any cross-polarization component products. A consequence of processing the polarization vector components separately is that there is no exploitation of the relative amplitude or relative phase shift between polarization parameters as part of the unmixing process.

An alternative to the long-vector method, which is applicable to polarization diverse arrays, maps the polarization components based on the Jones complex vector method. Complex vectors are closed under multiplication and satisfy commutative complex vector algebra. The Jones complex vector represents polarized electromagnetic waves as:

$$\overline{j} ≡ [ \begin{matrix}{\hat{E}}_{I}^{x} + i {\hat{E}}_{Q}^{x} \\ {\hat{E}}_{I}^{y} + i {\hat{E}}_{Q}^{y}\end{matrix} ] \qquad ( 1 )$$

In equation (1) the electric field of an incident wave is projected onto two orthogonal complex polar vectors: a linear horizontally polarized x-component and a linear vertically polarized y-component. Complex conjugation preserves polar symmetry and the rule for complex vector multiplication may be viewed as a consequence of the behavior of dilative rotations in 2-D space-time. The Jones complex vector method provides a polar-symmetric space (electric field) about a diagonal of a matrix corresponding to the complex vectors. However, the Jones complex vector method does not take into account an axial-symmetric space (magnetic field).

Yet another approach for separating or unmixing signals involves using in-phase and quadrature components, as disclosed in U.S. Pat. No. 7,123,191. A radio frequency (RF) includes an antenna array comprising N antenna elements for receiving at least N different summations of M source signals, where M>N. A respective in-phase and quadrature module is connected downstream to each antenna element for separating each one of the N different summations of the M source signals received thereby into an in-phase and quadrature component set. A blind signal separation processor forms a mixing matrix comprising at least 2N different summations of the M source signals, with each in-phase and quadrature component set providing 2 inputs into the mixing matrix. The mixing matrix has a rank equal up to 2N. The desired source signals are unmixed from the mixing matrix by the blind signal separation processor.

Similar to the '191 patent, U.S. Pat. No. 7,085,711 is directed to signal separation processing in which mixed signals are unmixed into estimates of their source signal components, wherein the number of signal sources exceeds that of the number of detecting sensors used by the corresponding RF device. In particular, the signal separation processing jointly optimizes a source signal estimate matrix and an estimated mixing matrix in an iterative manner to generate an optimized source signal estimate matrix and a final estimated mixing matrix. The separated source signals are restored from the optimized source signal estimate matrix, whereby a plurality of mixed signals from unknown sources traveling through an environment with added noise may be separated so that the original, separate signals may be reconstructed.

Both the '191 patent and the '711 patent utilize matrix mechanics during the unmixing of the source signals. Both also estimate how many source signals are in the mixture. As with the long-vector method and the Jones complex vector method, there is no exploitation of the relative amplitude or relative phase shift symmetry relations between polarization parameters as part of the unmixing process by any of the alternative approaches.

### SUMMARY OF THE INVENTION

In view of the foregoing background, it is therefore an object of the present invention to exploit elliptically polarized source signals.

This and other objects, features, and advantages in accordance with the present invention are provided by a radio frequency (RF) device comprising an antenna array for receiving elliptically polarized RF signals, a plurality of in-phase and quadrature modules coupled to the antenna array for generating a plurality of in-phase and quadrature components, and a homology group matched filter coupled to the plurality of in-phase and quadrature modules.

The homology group matched filter may generate a spectral results matrix based on the plurality of in-phase and quadrature components, and enables one to specify a polarization homology group matrix representing a polarized state of an estimated elliptically polarized signal source.

The homology group matched filter may apply at least one estimated source polarization homology parameter to an unmixing equation for generating unmixed elliptically polarized RF signals, with the unmixing equation being defined by the spectral results matrix and the polarization homology group matrix. An unmixed elliptically polarized RF signal level is generated based upon the at least one estimated source polarization homology parameter and the unmixed elliptically polarized RF signals. A threshold detector may be coupled to the homology grouped matched filter for determining if the unmixed elliptically polarized RF signal level is above some adaptive threshold corresponding to a specified false alarm rate.

The RF device advantageously provides a processing gain when the polarized signals are elliptically polarized. This processing gain is due to the momentum contribution from the elliptically polarized signals. In addition to the homology group matched filter taking into account a typical polar-symmetric space (electric field), an axial-symmetric space (magnetic field) is also taken into account. The axial-symmetric space (magnetic field) provides an additional discriminator for the elliptically polarized sources during the unmixing performed in the homology group matched filter. Incorporation of this momentum term into the unmixing equation within the homology group matched filter provides about a 3 dB increase in the total signal energy when there is an overall net momentum transfer. In addition, the method described herein makes no assumptions as to how many signals are in the mixture, only that signals in the mixture will satisfy symmetry relations.

The at least one estimated source polarization homology parameter may comprise a relative amplitude shift between the elliptically polarized RF signals when projected onto orthogonal space-time axes, a relative phase shift between the elliptically polarized RF signals upon projection, and linear phase progression parameters relating to azimuth and elevation angles of a direction of the elliptically polarized RF signals.

Applying the at least one estimated source polarization homology parameter to the unmixing equation may comprise applying incremented estimated source polarization homology parameters to the unmixing equation, with an unmixed elliptically polarized RF signal level being generated for each incremented parameter.

Each element in the polarization homology group matrix may comprise at least one of a quanternion number corresponding to an estimated elliptically polarized signal source at an array element, a sum of two complex numbers corresponding to the estimated elliptically polarized signal source, and a Hamiltonian matrix whose norm is invariant in time and corresponds to the total energy-momentum of the elliptically polarized signal source.

The antenna array may comprise a plurality of paired antenna elements, with each paired antenna elements comprising a horizontally polarized antenna element and a vertically polarized antenna element. The plurality of in-phase and quadrature modules may comprise a respective pair of in-phase and quadrature modules downstream from each paired antenna elements for generating a pair of in-phase and quadrature components. The antenna array comprises a phased array.

The threshold detector may comprise a constant false alarm rate (CFAR) detector. The RF device may further comprise a transmitter for transmitting elliptically polarized signals so that the RF device is configured as a radar, with the received polarized RF signals being reflected off of an object receiving the transmitted polarized signals.

Another aspect of the invention is directed to a method for unmixing dual polarized signals received by a radio frequency (RF) device comprising an antenna array, a plurality of in-phase and quadrature modules coupled to the antenna array, and a homology group matched filter coupled to the plurality of in-phase and quadrature modules. The method comprises receiving dual polarized RF signals at the antenna array, and generating a plurality of in-phase and quadrature components using the plurality of in-phase and quadrature modules.

The method may further comprise determining in the homology group matched filter an unmixing equation for generating unmixed dual polarized RF signals, and applying at least one estimated source polarization homology parameter to the unmixing equation in the homology group matched filter. In the homology group matched filter, an unmixed dual polarized RF signal level may be generated based upon the at least one estimated source polarization homology parameter and the unmixed dual polarized RF signals. The method may further comprise determining if the unmixed dual polarized RF signal level is above a threshold.

### BRIEF DESCRIPTION OF THE DRAWINGS

FIG. 1 is a block diagram of an RF device receiving polarized signals from different types of polarization sources in accordance with the present invention.

FIG. 2 is a block diagram of a radar system receiving elliptically polarized signals reflected from an object in accordance with the present invention.

FIG. 3 is a more detailed block diagram of the RF device illustrated in FIG. 1.

FIG. 4 illustrates a Riemann sphere in which a stereographic projection is made from a homogeneous position space-time coordinate to a point on the surface of the sphere in accordance with the present invention.

FIG. 5 illustrates a Riemann sphere in which a measurement is made at element x and the momentum space state of the source is represented by s in accordance with the present invention.

FIG. 6 is a plot illustrating processing gain results versus Γ=ε₂/ε₁ for several values of the polarization homology parameters (ε, φ) of two sources in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

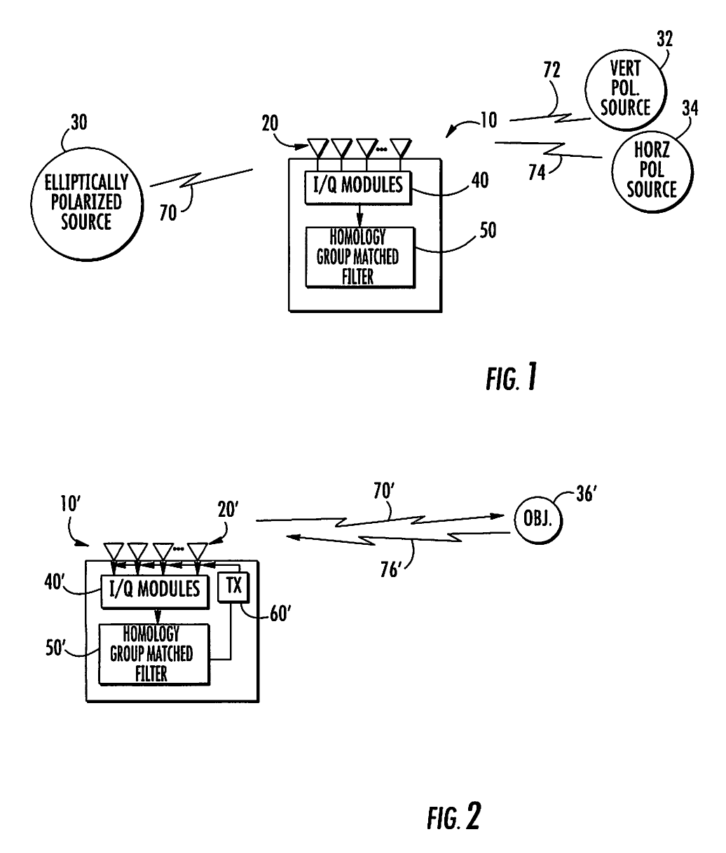

Referring initially to FIG. 1, a radio frequency (RF) device 10 includes a polarization diverse array 20 for receiving different summations of polarized signals. The polarized signals may be from a single source 30 if the signals are elliptically polarized 70. Otherwise, the polarized signals are from different sources, such as a source 32 providing vertically polarized signals 72 and a source 34 providing horizontally polarized signals 74. As an alternative, at least one of the vertically and horizontally polarized signal sources 32, 34 may be replaced with a circularly polarized signal source. Other types of polarizations are applicable, as readily appreciated by those skilled in the art.

In-phase (I) and quadrature (Q) modules 40 (also known as quadrature detectors and converters) are used to separate the different summations of the polarized signals into in-phase and quadrature component sets for input to a homology group matched filter 50. As will be explained in greater detail below, there is a processing gain when the polarized signals are elliptically polarized. This processing gain is due to the momentum contribution from the elliptically polarized signals.

In other words, in addition to taking into account a typical polar-symmetric space (electric field), the homology group matched filter 50 also takes into account an axial-symmetric space (magnetic field). The axial-symmetric space (magnetic field) provides an additional discriminator for the elliptically polarized sources 70 during the unmixing performed in the homology group matched filter 50. Incorporation of this momentum term into a matched filter unmixing equation within the homology group matched filter 50 provides about a 3 dB increase in the total signal energy when there is an overall net momentum transfer.

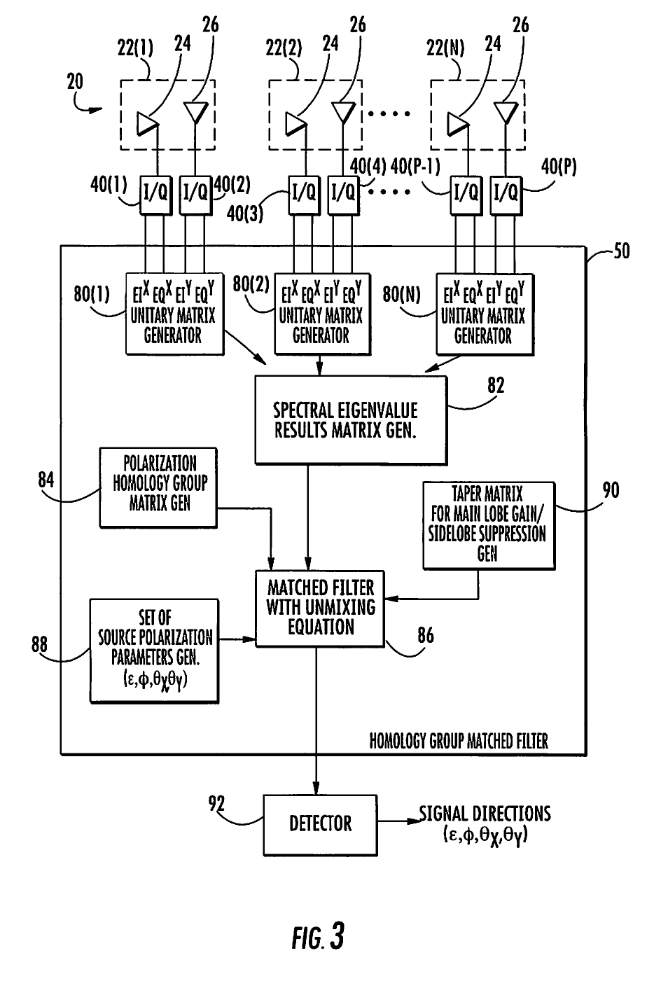

As shown in FIG. 1, the RF device 10 is a receiver configured for determining a direction of any one of the polarized signals 70, 72, 74 received from their respective polarization sources 30, 32, 34. In another embodiment as illustrated in FIG. 2, the RF device 10′ includes a transmitter 60′ for forming a radar system, such as a synthetic aperture radar, for example. The elliptically polarized signals 70′ are transmitted by the transmitter 60′, and are reflected 76′ off of an object 36′ back to the antenna array 20′. The direction of the object 36′ reflecting the elliptically polarized signals 76′ is determined by the homology group matched filter 40′.

The RF device 10 will now be discussed in greater detail with reference to FIG. 3 in terms of receiving elliptically polarized signals. Because the signals are elliptically polarized, the RF device 10 exploits relative amplitude and/or relative phase shift polarization homology parameters in the unmixing process for separating the different summations of the elliptically polarized signals. The antenna array 20 provides dual polarization, and comprises a plurality of paired antenna elements 22(1)-22(n) for receiving the different summations of the elliptically polarized signals.

Each paired antenna element 22 is dual polarized, and includes a horizontally polarized antenna element 24 and a vertically polarized antenna element 26. The paired antenna elements 22(1)-22(n) are active antenna elements so that the antenna array 20 forms a phased array.

In-phase and quadrature modules 40(1)-40(p) are downstream from the antenna array 20 for separating the different summations of the elliptically polarized signals into I and Q component sets. In the illustrated example, the variable p=2*n. Each antenna element 24, 26 has a respective in-phase and quadrature module 40 coupled thereto. The in-phase and quadrature modules 40(1)-40(p) coupled to the respective horizontally and vertically polarized antenna elements 24, 26 provide a pair of I and Q component sets (E_{I}^{x}, E_{Q}^{x}, E_{I}^{y}, E_{Q}^{y}) to a homology grouped matched filter 50.

The homology grouped matched filter 50 may be implemented by a signal processor executing an algorithm. The homology grouped matched filter 50 includes unitary matrix generators 80(1)-80-(n) for representing each corresponding pair of I and Q component sets (E_{I}^{x}, E_{Q}^{x}, E_{I}^{y}, E_{Q}^{y}) as a unitary matrix. Each unitary matrix is used by a spectral eigenvalue results matrix generator 82 to form a spectral eigenvalue results matrix. A polarization homology group matrix generator 84 generates a polarization homology group matrix representing a polarized state of at least one of the elliptically polarized signal sources. A matched filter 86 with an unmixing equation is formed based on the spectral eigenvalue results matrix and the polarization homology group matrix.

Source polarization homology parameters generator 88 generates at least one set of source polarization homology parameters to be applied as input to the matched filter 86 for unmixing the different summations of the elliptically polarized signals. The output of the matched filter 86 is an unmixed elliptically polarized RF signal level based upon the at least one set of estimated source polarization homology parameters and the unmixed elliptically polarized RF signals.

Each set of source polarization homology parameters comprises a relative amplitude shift ε between the elliptically polarized signals, a relative phase shift φ between the elliptically polarized signals, and linear phase progression terms (θₓ, θ_{y}) which can be related to azimuth and elevation angles (θₓ, θ_{y}) of the direction of a corresponding elliptically polarized signal source.

An energy or signal level of the unmixed elliptically polarized signals is determined based on the at least one applied set of source polarization homology parameters and the unmixed elliptically polarized signals. A threshold detector 92 is coupled to the homology grouped matched filter 50 for determining if the at least one applied set of source polarization homology parameters corresponds to a direction of the at least one elliptically polarized signal source based on a comparison of the corresponding energy level to a threshold. The detector 92 may be a constant false alarm rate (CFAR) detector, for example.

The at least one set of source polarization homology parameters may be applied over a period of time, and the corresponding energy level of the polarization state is based over the period of time. A taper matrix generator 90 generates a taper matrix that may also be applied as input to the matched filter 86 for tradeoff of mainlobe gain/sidelobe suppression for the antenna array 20.

As discussed in the background section, the Jones complex vector represents polarized electromagnetic waves as provided by equation (1). The electric field of an incident wave is projected onto two orthogonal complex polar vectors: a linear horizontally polarized x-component and a linear vertically polarized y-component. The two complex x- and y-components of the complex vector in equation (1) are composed of four real samples. One can alternatively project these samples onto a basis set of unitary matrices as follows:

$${\hat{E}}_{I}^{x} [ \begin{matrix}1 & 0 \\ 0 & 1\end{matrix} ] + {\hat{E}}_{Q}^{x} [ \begin{matrix}ι & 0 \\ 0 & - i\end{matrix} ] + {\hat{E}}_{I}^{y} [ \begin{matrix}0 & 1 \\ - 1 & 0\end{matrix} ] + {\hat{E}}_{Q}^{y} [ \begin{matrix}0 & - i \\ - i & 0\end{matrix} ] = [ \begin{matrix}{\hat{E}}_{I}^{x} + i {\hat{E}}_{Q}^{x} & {\hat{E}}_{I}^{y} - i {\hat{E}}_{Q}^{y} \\ - {\hat{E}}_{I}^{y} - i {\hat{E}}_{Q}^{y} & {\hat{E}}_{I}^{x} - i {\hat{E}}_{Q}^{x}\end{matrix} ] ≡ \hat{H} \qquad ( 2 )$$

Equation (2) projects the antenna array's 20 I and Q samples from linear-horizontal and linear-vertical polarization elements 24, 26 (for each paired antenna element 22 in the antenna array 20) onto the quaternion basis. The first three matrices in equation (2) are directly related to the Pauli spin matrices (a) applied in quantum mechanics (by either a polar or an axial reflection operation) and neglecting the quantum scale factor. These matrices serve the same role here as in their application in quantum mechanics: square-roots of observed angular momentum states. The real components of Eₓ and E_{y} are projected onto a set of orthogonal unit polar vectors, and the imaginary components onto a set of unit axial vectors. The polar-symmetric column vectors and axial-symmetric column vectors can be segregated into two matrices P and Q formed from the decomposition of H:

H=P+iQ (3)

Yang-Mills Theory also utilizes a non-abelian generalization of the electric and magnetic fields replacing each of the electric and magnetic potential vectors in Maxwell's Equations by a matrix. Elliptically polarized photons interact with electrons by inducing a relativistic Thomas precession of their spin axes towards a principle orientation in momentum space. This is the reason for the intimate relationship between elliptical polarization states and spin-momentum states.

Based on these arguments, the Hamiltonian (H) representation of equation (2) is understood to be the observable corresponding to the total energy-momentum of the signal mixture. By using a quaternion basis, angular momentum spin states can now be utilized as a discriminator between elliptically polarized sources during the unmixing. In terms of the nature of helical phase-fronts, a spatial rotation of the beam is indistinguishable from its temporal evolution.

Hence, a symmetry relation between a rotation in space and a phase change (rotation in time) can be established for elliptically polarized sources. The quaternion basis preserves the orientation of the helicity of the phase-fronts under space-time reflections, which is necessary in order for the positive and negative helicity paths to cancel during contour integration of analytic space-time Hamiltonians.

The homology group matched filter 50 will now be discussed in greater detail. Based on geometrical considerations from relativity, the space-time distance metric is invariant in all inertial reference frames. However, more fundamental than these geometrical considerations associated with metric preservation are the underlying group-theoretic symmetry invariants. Groups can be represented by matrices characterizing some symmetry in a geometric space or homology in topological spaces. A symmetry or homology is related to an invariant property, for polarized sources. The invariant property is commonly referred to as the polarization ellipse, with an eccentricity ε and an orientation φ.

Instead of interpreting the polarization state as the equation of an ellipse, an interpretation in terms of the preservation of a homology is possible. The parameters ε and φ do not depend on the absolute values of the coordinates (E_{I}^{x}, E_{Q}^{x}, E_{I}^{y}, E_{Q}^{y}), but rather on the ratio between the x- and y-components. Hence, ε and φ correspond to homogeneous coordinates, and an infinite group of (E_{I}^{x}, E_{Q}^{x}, E_{I}^{y}, E_{Q}^{y}) position space-time points are represented by the projective invariant (ε, φ). One can formally express this projective invariant (homology equivalence class) as the mean ratio of two complex numbers, E^{x} and E^{y}, for 2K+1 samples, such that:

$${r}_{d} = \frac{1}{2 K + 1} {\sum }_{k = - K}^{K} \frac{{E}_{I}^{y} ( k ) + i {E}_{Q}^{y} ( k )}{{E}_{I}^{x} ( k ) + i {E}_{Q}^{x} ( k )} {⇒}^{CRC} p + i q = ɛ {e}^{i ϕ} \qquad ( 4 )$$

A given polarization source always has an invariant multiplicative r_{d} factor (dilative rotation) between the x- and y-components. In other words, all coordinates (E_{I}^{x}, E_{Q}^{x}, E_{I}^{y}, E_{Q}^{y}) for which equation (4) is constant are elements of the same polarization homology equivalence class. In general, equation (4) is related to the Laurent Series, and when the space-time Hamiltonian is analytic this series converges to a point invariant set in momentum space.

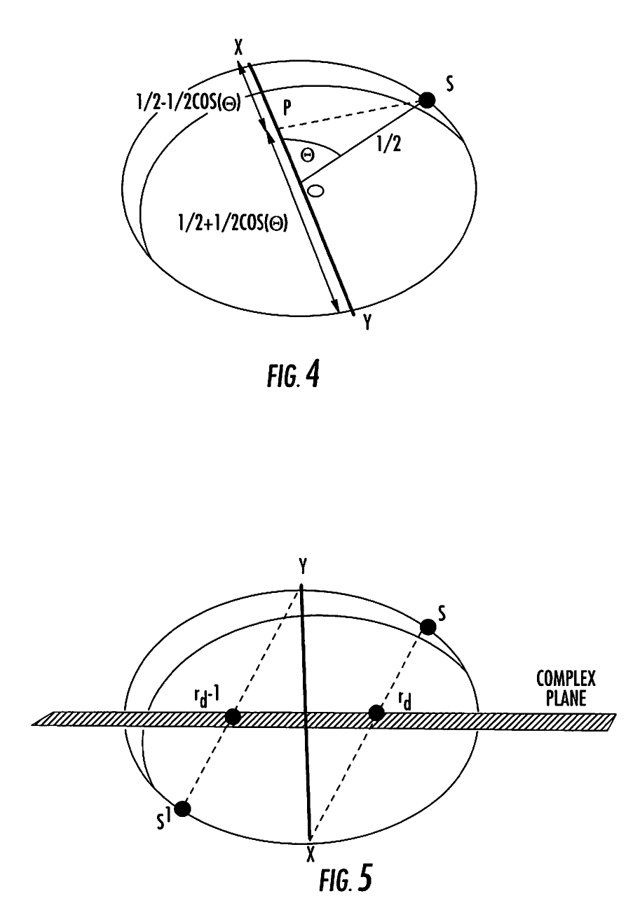

Momentum spaces are more typically characterized by a Fourier Series, which can be expressed as a Laurent Series about a given space-time point. From the perspective of topology, position space-time is homeomorphic to a Riemann sphere as harmonic loops (closed contours) in position space-time project to points on the Riemann sphere. The homology classes of both spaces are equivalent and the Riemann sphere provides a convenient visualization of the effects of projections between position space-time and momentum space. FIG. 4 provides an illustration of the stereographic projection from a homogeneous position space-time coordinate to a point on the surface of the Riemann sphere.

In FIG. 4, x and y represent the measurement axes in the reference frame of momentum space. While the x- and y-axes are orthogonal in position space-time, in fermionic momentum space they are antipodal since the electrons spin ½ particles and it is the collective states of electrons (after interaction with source photons) which are measured by the antenna array 20. In fact, all angles in position space-time are doubled upon projection into a spin ½ momentum space. To determine the momentum space state corresponding to an observation at element x, we stereographically project from the south pole (x-orientation) through the point r_{d} in the homogeneous complex plane until it intersects with the surface of the Riemann sphere at s, and conversely for the y-orientation projection.

When the real parts of the positive and negative frequency components are even symmetric and the imaginary parts are odd symmetric (complex conjugates), the observed function is analytic. However, even if the function is not strictly analytic, it may still satisfy the requirements of a hyperfunction, which is the homology equivalence class of a pair of holomorphic functions defined on the northern and southern hemispheres of the Riemann sphere and whose Laurent Series still converges.

To gain yet another perspective, one can examine an alternative representation of equation (2) based on a real 4×4 matrix. This real matrix can be decomposed as the sum of a real polar-symmetric and a real axial symmetric matrix, taking the form of a wave function for two harmonic oscillators:

$$H = \frac{1}{2} ( H + {H}^{T} ) + \frac{1}{2} ( H - {H}^{T} ) \qquad ( 5 )$$

The first polar-symmetric term is a representation of potential energy and is consistent with complex vector algebra utilized by the complex vector method. The second axial-symmetric term is a representation of kinetic energy (angular momentum) satisfying an orthogonal Lie algebra. Incorporation of the angular momentum term is predicted by equation (5) to incorporate a factor of ½ increase into the total signal energy when there is an overall net angular momentum transfer. This equates to a 3 dB signal processing gain in terms of an energy ratio relative to the Jones complex vector method.

With respect to time, the observed energy flows from the polar-symmetric representation to the axial-symmetric representation. At the instant when the energy exhibits total polar-symmetry, the orthogonal polar vectors have a vanishing inner product. While at the instant when the energy exhibits total axial-symmetry, the orthogonal axial vectors are directed towards antipodal points. At any intermediate time, the Hamiltonian representation is a mixture of the two pure symmetry states. The norm of the Hamiltonian, which is the total energy-momentum in the signals, is constant assuming a conservative dynamical system. Thus, in this joint representation, we find that energy flows from a polar-symmetric space (electric field) to an axial-symmetric space (magnetic field) with the evolution satisfying the Cauchy-Riemann Conditions (CRC):

$$\frac{\partial P}{\partial p} = \frac{\partial Q}{\partial q} , \frac{\partial P}{\partial q} = - \frac{\partial Q}{\partial p} \qquad ( 6 )$$

The Cauchy-Riemann conditions insure that contour integration is path-independent along any other path that is obtained from the first by a homologous deformation. With a homologous deformation it is legitimate for parts of paths to cancel one another out, provided that these portions are being traversed in opposite directions. Two paths that are deformable one into the other belong to the same homology equivalence class and preserve equation (4). Chow's Theorem proves that these closed analytic subspaces are isometric with algebraic cycles on complex projective varieties. The value of ε in equation (4) can now be understood in terms of the geometry of the Riemann sphere. Suppose we are making a measurement at element x and the momentum space state of the source is represented by s in FIG. 5.

For fermionic momentum spaces the radius of the Riemann sphere is ½ since these are spin ½ particles. A spin vector from the Origin (O) to s specifies the principle orientation of the spin-axis of electrons which have interacted with elliptically polarized photons from this source. To derive the amplitudes density (e) that will be observed in position space-time, one projects s orthogonally onto the x-y axis until it intersects at point P. One finds that the amplitude observed at element x is proportional to the length XP and that the amplitude observed at element y is proportional to the length PY. The principle direction of the spin vector relative to the reference orientation is θ and it is the angle between OX and OS. Based on this geometry, the amplitude density observed in position space-time relates to the following angle in projective momentum space:

$$ɛ = \frac{\frac{1}{2} ( 1 + cos ( θ ) )}{\frac{1}{2} ( 1 - cos ( θ ) )} \qquad ( 7 )$$

Thus, the geometry of the Riemann sphere equates the complex numbers (x, y) of the antenna array 20 directly to the spatial orientation of the spin axis unique to each individual elliptically polarized source. This can be done because the projection onto the surface of the Riemann sphere is conformal. The parameter ε corresponds to the invariant Lagrangian action obtained from contour integration. Conjugate quantum measurements correspond to measurements taken at antipodal points on the Riemann sphere. The complete set of symmetries of the Riemann sphere are described by the Mobius transformation group PSL(2, C) which is isomorphic as an orthogonal Lie group to the Lorentz group (group of all Lorentz transformations of Minkowski space-time). Thus, the properties of the Riemann sphere satisfy the constraints of both quantum mechanics and relativity.

The relative phase shifts between antenna elements along the antenna axes, which are related to the sources angle of arrival (AOA) of the incident radiation (θₓ and θ_{y}), are also homogeneous coordinates since they do not depend on the actual phase values at array elements only on their relative phase shifts. The entire set of homogeneous source parameters can be represented as a single polarization homology class. For a given polarized source, the polarization homology class is invariant. The Cayley-Dickson construction enables one to represent the 2×2 complex Hamiltonian matrix of equation (2) as a single quaternion number:

s=x+jy

y=Êₗ^{x}+iÊ_{Q}^{x}

y=Êₗ^{y}+iÊ_{Q}^{y} (8)

In the hypercomplex representation one may appreciate that instead of just temporal phase (i), there is now also the notion of spatial phase (j). Rotation by j refers to a spatial rotation of the x-axis by π/2. The Hodge Conjecture states that rational homology equivalence classes of closed differential harmonic forms arising from a nonsingular projective complex algebraic variety can be viewed as solutions of the elliptic Laplace equation. A relation between quaternions and the 3-D Laplace equation was established by Hamilton. However, the principles of relativity requires that space and time be treated in an integrated manner since it is a space-time interval which is invariant between inertial reference frames. The 2-D space-time Laplace equation can be factored into a form corresponding to infinitesimal generators of the group of unitary transformations:

$${∇}^{2} H = \frac{{\partial }^{2} H}{\partial {p}^{2}} + \frac{{\partial }^{2} H}{\partial {q}^{2}} = ( \frac{\partial H}{\partial p} + j \frac{\partial H}{\partial q} ) ( \frac{\partial H}{\partial p} - j \frac{\partial H}{\partial q} ) = 0 \qquad ( 9 )$$

To prove that equation (9) is zero, one only needs to prove that one factor or the other is always equal to zero. Complex multiplication is a dilative rotation and this factored form of Laplace's equation demonstrates that the Laplacian is essentially a dilative rotation in 2-D space-time. One can prove that the first conjugate solution is zero as follows. Inserting the relation of equation (3), the first conjugate factor in equation (9) becomes:

$$\frac{\partial ( P + i Q )}{\partial p} + j \frac{\partial ( P + i Q )}{\partial q} = 0 \qquad ( 10 )$$

For elliptically polarized sources, a spatial rotation is indistinguishable from temporal evolution (axial symmetry) so j=i, and one obtains:

$$\frac{\partial P}{\partial p} - \frac{\partial Q}{\partial q} + i ( \frac{\partial Q}{\partial p} + \frac{\partial P}{\partial q} ) = 0 \qquad ( 11 )$$

Substituting in the Cauchy-Riemann conditions of equation (6), one can verify that equation (11) is true (both real and imaginary parts are equal to zero). For the second factor, one could input the conditions for linearly polarized sources (polar-symmetry) where (j=−i) and one could verify that this expression is also valid. These results demonstrate that however one settles the sign convention, the relation can be proven for either polar or axial symmetric conditions.

Momentum states are the irreducible representations of each polarized source, and are conjugate roots solving the 2-D space-time Laplace Equation. Each source induces a unique space-time rotation of a quaternion vector whose norm is the energy-momentum of the signal. This can be done because complex numbers preserve their norms under multiplication (dilative rotation). The norm of p₁+jp₂ is p₁²+p₂². The sum of squares formula verifies this invariance of the norms:

(p₁²+p₂²)(q₁²+q₂²)=(p₁q₂+p₁q₂)²+(p₁q₂−p₁q₂)² (12)

The norm preservation in equation (12) holds only for normed division algebras, of which complex vector algebra and quaternion algebra (the case when p₁, p₂, q₁, and q₂ are themselves complex numbers) are instances. Hodge's conjecture states it is possible to write the homology classes as the sum of harmonic (p, q) differential forms solving the 2-D space-time Laplace's equation in this application. However, instead of Hodge's original statements about invariant homology classes of topological spaces, homeomorphisms between topological spaces are more conveniently investigated via homology groups.

Homology groups respect homeomorphic relations between topological spaces and are representations of the algebraic invariants (homology classes) identified by Hodge. This suggests an approach for determining a group-theoretic similarity relation useful for polarized source unmixing. A polarization homology group representation (G_{(p,q)}) of a polarization state is constructed as follows for a planar array using a group representation of closed contour differential harmonic forms which sum coherently in time and space:

$$\begin{matrix}{G}_{( p , q )} ( ɛ , ϕ , {θ}_{x} , {θ}_{y} ) = {G}_{P} ( {θ}_{x} ) + {G}_{q} ( ɛ , ϕ , {θ}_{y} ) = \\ [ \begin{matrix}1 + j ɛ {e}^{i ϕ} & 1 + j ɛ {e}^{i ( ϕ - {θ}_{y} )} & … & 1 + j {ɛ}^{i ( ϕ - ( N - 1 ) {θ}_{y} )} \\ {e}^{- i {θ}_{x}} + j ɛ {e}^{i ϕ} & {e}^{- i {θ}_{x}} + j ɛ {e}^{i ( ϕ - {θ}_{y} )} & … & \begin{matrix}{e}^{- i {θ}_{x}} + \\ j {ɛ}^{i ( ϕ - ( N - 1 ) {θ}_{y} )}\end{matrix} \\ … & … & … & … \\ \begin{matrix}{e}^{- i ( N - 1 ) {θ}_{x}} + \\ j ɛ {e}^{i ϕ}\end{matrix} & \begin{matrix}{e}^{- i ( N - 1 ) {θ}_{x}} + \\ j {ɛe}^{i ( ϕ - {θ}_{y} )}\end{matrix} & … & \begin{matrix}{e}^{- i ( N - 1 ) {θ}_{x}} + \\ j ɛ {e}^{i ( ϕ - ( N - 1 ) {θ}_{y} )}\end{matrix}\end{matrix} ]\end{matrix} \qquad ( 13 )$$

Homology groups merge the Hamiltonian and Lagrangian formalisms and algebraically relate the Laplacian operator and contour integrals. The principle of least action produces a minimal surface in the relativistic picture. It is holomorphic curves in momentum space that correspond to these minimal surfaces in position space-time. Each element of the matrix in equation (13) is itself a quaternion, and the matrix itself represents the symplectic group Sp(N). It is because of the sympletic Lie algebra of infinitesimal generators of the symplectic Lie group of equation (13) that this unmixing problem can be solved algebraically and one does not need to explicitly utilize calculus.

However, knowledge of the underlying calculus still facilitates understanding, as in the appreciation that solutions of Laplace's equation are obtained. In equation (13) θₓ and θ_{y} are phase delays which can be related to source AOAs along the x- and y-axes respectively. In the conventional manner, only with quaternion numbers as measured values, one may form a spectral eigenvalue matrix (which is Toeplitz in the absence of noise) across two sets of N samples from the x- and y-dimensions respectively:

$$\hat{Ω} = [ \begin{matrix}{\hat{H}}_{x 1}^{H} {\hat{H}}_{y 1} & {\hat{H}}_{x 1}^{H} {\hat{H}}_{y 2} & … & {\hat{H}}_{x 1}^{H} {\hat{H}}_{y N} \\ {\hat{H}}_{x 2}^{H} {\hat{H}}_{y 1} & {\hat{H}}_{x 2}^{H} {\hat{H}}_{y 2} & … & {\hat{H}}_{x 2}^{H} {\hat{H}}_{y N} \\ … & … & … & … \\ {\hat{H}}_{x N}^{H} {\hat{H}}_{y 1} & {\hat{H}}_{x N}^{H} {\hat{H}}_{y 2} & … & {\hat{H}}_{x N}^{H} {\hat{H}}_{y N}\end{matrix} ] \qquad ( 14 )$$

In equation (14), the observed Hₓᵢ and H_{yi} signals are the group sums (rather then the conventional vector sums) of each individual source contribution. Since H is Hermitian it is commutative with respect to its product with its adjoint. Applying equations (13) and (14) one can unmix the signal energy of a specified non-Abelian polarization homology group from a signal mixture collected from a planar array using the following discriminant function which inverts the dilative space-time rotation unique to each specified source:

ŝ(ε,φ,θₓ,θ_{y})=∥(G_{(p,q)}(ε,φ,θₓ,θ_{y})^{H}(T·\hat{Ω})G_{(p,q)}(ε,φ,θₓ,θ_{y}))∥⁻¹ (15)

Equation (15) has a local maximum when the source (ε, φ, θₓ, θ_{y}) occurs in the mixture. It is a matched filter for signals with a homology group representation. In equation (15), the Hadamard product of equation (14) with a taper matrix T allows one to trade mainlobe gain for sidelobe suppression based on application requirements. The detector 92 may apply a Constant False Alarm Rate (CFAR) algorithm to detect sources while maintaining a desired false alarm rate against background noise. A derivation similar to this one has been performed for a linear array configuration and a relationship between an unmixing equation similar to equation (15) and the MUltiple SIgnal Classification (MUSIC) algorithm has been established.

Conditions under which quaternion representations diverge from complex vector representations will now be discussed. Consider two sources, s₁ and s₂, irradiating the sensor in terms of their hypercomplex signal representations:

s₁=x₁+jy₁

s₂=x₂+jy₂ (16)

The Hermitian inner product between the two hypercomplex signals (expressed in the Dirac notation) is equivalent to the following (as each term in the hypercomplex representation is itself a complex number):

[symbol]

s₁|s₂ [symbol] =(x₁^{H}−jy₁^{H})(x₂+jy₂) (17)

When the spatial imaginary part of the product in equation (17) vanishes, the hypercomplex representation contains only auto-terms and leads to the equation:

[symbol]

ⱼ{ [symbol] s₁|s₂ [symbol] }=x₁^{H}x₂+y₁^{H}y₂ (18)

Upon inspection, equation (18) is a complex vector inner product and represents a polar-symmetric orthogonality constraint. Thus, the spatial imaginary component of the hypercomplex representation of the product in equation (17) leads to an additional constraint equation for signal subspaces applied when using group products, and one which involves cross-terms:

[symbol]

ⱼ{ [symbol] s₁|s₂ [symbol] }=x₁^{H}y₂−y₁^{H}x₂ (19)

The following are conditions under which the spatial imaginary component in equation (19) vanishes:

x₁^{H}y₂−y₁^{H}x₂=0

or

x₁^{H}y₂=y₁^{H}x₂ (20)

This is the symmetry relation between temporal and spatial reflections which is invariant for elliptically polarized sources. To further investigate the conditions under which the spatial imaginary component vanishes (and thus the conditions under which the complex vector basis and quaternion basis are identical), assume that the two sources (s₁ and s₂) are elliptically polarized. Elliptically polarized sources have the following hypercomplex representations in position space-time:

y₁=x₁ε₁e^{jφ}^{₁}

y₂=x₂ε₂e^{jφ}^{₂} (21)

Where (ε₁, φ₁) and (ε₂, φ₂) are the homology equivalence classes of the two sources, respectively. Inserting the expressions of equations (21) into (20), one obtains:

x₁^{H}(x₂ε₂e^{jφ}^{₂})=(x₁^{H}ε₁e^{jφ}^{₁})x₂ (22)

Rearranging terms and recalling that the complex number j is not affected by a Hermitian operator over the complex number i, the expression reduces to:

x₁^{H}x₂(ε₂e^{jφ}^{₂})=x₁^{H}x₂(ε₁e^{jφ}^{₁})

or

ε₂e^{jφ}^{₂}=ε₁e^{jφ}^{₁} (23)

In equation (23) one discovers that the spatial imaginary component equals zero when each of the two polarized sources belong to the same homology class (ε₂=ε₁ and φ₂=φ₁). These are the conditions under which the quaternion basis is equal to the complex vector basis. Alternatively, when there is more than one source and it has a unique (ε, φ) homology from the first, the quaternion basis provides a distinct representation.

Numerical simulation results will now be discussed. The processing gain of the quaternion basis with respect to the complex vector basis is given by:

$${g}_{p} = 20 \cdot {log}_{10} ( \frac{\sqrt{{( {x}_{1}^{H} {x}_{2} + {y}_{1}^{H} {y}_{2} )}^{2} + {( {x}_{1}^{H} {y}_{2} - {y}_{1}^{H} {x}_{2} )}^{2}}}{\sqrt{{( {x}_{1}^{H} {x}_{2} + {y}_{1}^{H} {y}_{2} )}^{2}}} ) \qquad ( 24 )$$

The second term under the square root in the numerator of equation (24) is the additional gain contribution resulting from mapping onto the quaternion basis as opposed to the complex vector basis in equation (19). The processing gain achieved is scenario dependent, but in an attempt to generalize the results to as great an extent as possible, one may define Γ=ε₂/ε₁.

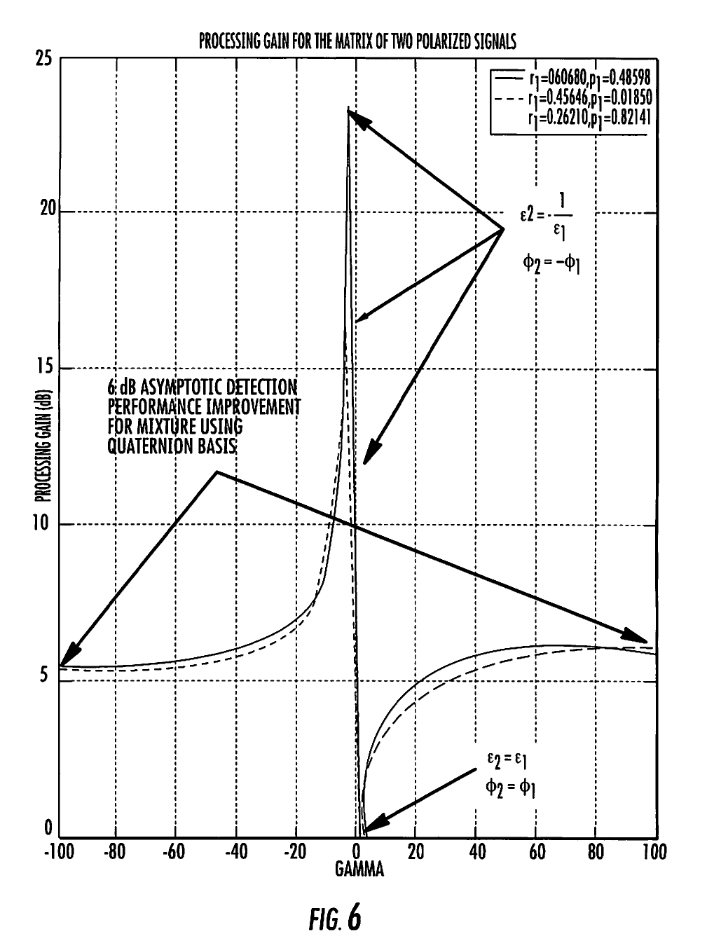

FIG. 6 presents processing gain results versus Γ for several values of the polarization homology parameters (ε, φ). In FIG. 6, it is observed that there is an improvement in terms of the signal energy projected onto the quaternion basis versus the complex vector basis with an asymptotic processing gain of 6 dB (for the mixture of the two sources). This agrees with the 3 dB magnitude of momentum contributions to the Hamiltonian in equation (5) from each elliptically polarized source. The peak processing gain for a specific Γ is understood to occur when the denominator of equation (24) vanishes (or equivalently when equation (18) vanishes)), such that:

x₁^{H}x₂+y₁^{H}y₂=0 (25)

In a manner analogous to when we found the roots of equation (18) we substitute the relations of equation (21) into equation (25), to find the relations among the ε and φ values at which the peak processing gain occurs:

x₁^{H}x₂+(x₁ε₁e^{jφ}^{₁})^{H}(x₂ε₂e^{jφ}^{₂})=0 (26)

Rearranging terms:

x₁^{H}x₂(1+ε₁ε₂e^{j(φ}^{₁}^{φ}^{₂}⁾)=0 (27)

Finally, one discovers the relation:

ε₁ε₂e^{j(φ}^{₁}^{+φ}^{₂}⁾=−1 (28)

The ε and φ relations which satisfy equation (28) are:

$$\begin{matrix}\begin{matrix}{ɛ}_{2} = - \frac{1}{{ɛ}_{1}} \\ and\end{matrix} \\ {ϕ}_{2} = - {ϕ}_{1}\end{matrix} \qquad ( 29 )$$

Geometrically, the constraints of equation (29) are understood to be antipodal points (s and s′) on the Riemann sphere and impose the axial-symmetry orthogonality constraint. In summary, if there is a pair of sources in the mixture that approach ε₂→−1/ε₁ and φ₂→−φ₁, then the detection performance of the quaternion basis provides a significant improvement over the complex vector basis. Under most conditions, for pairs of elliptically-polarized sources which are not antipodal, a 3 dB processing gain is predicted for the quaternion basis relative to the complex vector basis for each source.

Implementation considerations will now be discussed. The ideal signal processing gains in FIG. 6 will not be precisely replicated in a practical implementation due to some additional considerations. For one, gain is typically deliberately decreased by adding the matrix taper of equation (15) to improve sidelobe suppression. Also, this analysis is based on a narrowband assumption and the simplified homologies identified are precisely true at one specific frequency. When the narrowband assumption is relaxed, sources cannot always be segregated into projective invariant point sets in equation (4). Steady-state solutions of the mixture may depend not just on relative phase differences, but may be dependent on absolute phase values.

When the frequency ratios of two sources are commensurate, the signal mixture is characterized by a quasi-periodic invariant set and evolves as a curve on the surface of a torus, as predicted by Kolmogorv, Arnold, Moser (KAM) Theory, instead of as a point on the surface of the Riemann sphere (conformal invariance is broken by non-linear interactions). The quasi-periodic invariant sets depend on the absolute phase values of each source and the steady-state solutions can be determined numerically as the contour integral becomes path dependent.

More details on the dynamics of Ruelle-Takens-Newhouse cascades to strange invariant sets can be found in the article titled “Analysis Methodology for Simulation of Distributed Adaptive Routing Systems”, Arthur Olsen, Association of Computing Machinery (ACM) Computer Communications Review, Volume 27, Number 5, October 1997.

However, wideband applications can still benefit from this algorithm by applying it independently in each subband after decomposition by a filter bank. A key distinction of the quaternion approach is that it forms the steering matrix of equation (13) instead of steering vectors. Steering vector variance is a primary limitation of geo-location accuracy and the larger the dynamic range requirement, the smaller the required steering vector variance. The variance in the steering vector is typically more sensitive to quantization noise than thermal noise. FIG. 4 for SNR performance assumes that the noise is uncorrelated with the signal.

However, quantization noise is correlated with the amplitude and phase of the signal and in this way becomes correlated across subband channels. Correlated quantization noise does not allow SNR improvement through coherent processing. Since ε and φ are based on relative ratios and not absolute levels it is expected that the effects of quantization noise on the final unmixed solution are less extreme than the vector-based unmixing solution based only on θₓ and θ_{y}. Quantization noise also factors into the design considerations of the CFAR algorithm applied to equation (15) as one needs to compensate for the possibility of correlated background noise for optimal performance.

Problems become ill-conditioned when pairs of column vectors in the covariance matrix (in vector approaches) or the density matrix (Ω) in this approach are nearly parallel. But, as this approach applies an additional momentum-space orthogonality constraint beyond that applied for the complex vector-basis, the conditioning of the density matrix is improved relative to that of the covariance matrix. Consequently, for a given machine precision less extreme rounding errors occur for the quaternion basis than for the vector basis.

In conclusion, unmixing performance when multiple elliptically-polarized sources are projected onto complex vector and quaternion bases has been discussed. This unmixing is based on a homology group theory that is able to unmix elliptically polarized signals. When all sources belong to the same homology equivalence class (ε, φ), the unmixing performance of homology group representations on a quaternion basis are identical to that using a complex vector basis.

However, this results in a significant detection performance improvement against diverse elliptically polarized mixtures resulting from the inclusion of angular momentum contributions to the Hamiltonian representation of the polarized signal mixture and incorporation of both polar-symmetric and axial-symmetric orthogonality constraints. Homology group matched filtering has broad applicability to signal processing algorithms for polarization-diverse arrays.

Another aspect of the invention is directed to a method for unmixing dual polarized signals received by the above-described RF device 10. The method comprises receiving dual polarized RF signals at the antenna array 20, and generating a plurality of in-phase and quadrature components using the plurality of in-phase and quadrature modules 40. The method further comprises determining in the homology group matched filter 50 an unmixing equation for generating unmixed dual polarized RF signals, and applying at least one estimated source polarization homology parameter to the unmixing equation in the homology group matched filter. In the homology group matched filter 50, an unmixed dual polarized RF signal level is generated based upon the at least one estimated source polarization homology parameter and the unmixed dual polarized RF signals. The method further comprises determining if the unmixed dual polarized RF signal level is above a threshold.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A radio frequency (RF) device comprising:
an antenna array for receiving dual polarized RF signals;
a plurality of in-phase and quadrature modules coupled to said antenna array for generating a plurality of in-phase and quadrature components;
a homology group matched filter coupled to said plurality of in-phase and quadrature modules for
determining an unmixing equation for generating unmixed dual polarized RF signals,
applying at least one estimated source polarization homology parameter to the unmixing equation, and
generating an unmixed dual polarized RF signal level based upon the at least one estimated source polarization homology parameter and the unmixed dual polarized RF signals; and
a threshold detector coupled to said homology grouped matched filter for determining if the unmixed dual polarized RF signal level is above a threshold.

2. The RF device according to claim 1 wherein the dual polarized RF signals comprise elliptically polarized signals.

3. The RF device according to claim 1 wherein the at least one estimated source polarization homology parameter comprises a relative amplitude shift between the dual polarized RF signals, a relative phase shift between the dual polarized RF signals, and azimuth and elevation angles of a direction of the dual polarized RF signals.

4. The RF device according to claim 1 wherein applying the at least one estimated source polarization homology parameter to the unmixing equation comprises applying incremented estimated source polarization homology parameters to the unmixing equation, with an unmixed dual polarized RF signal level being generated for each incremented parameter.

5. The RF device according to claim 1 wherein said homology group matched filter applies a taper matrix to the unmixing equation for trading mainlobe gain for sidelobe suppression of said antenna array.

6. The RF device according to claim 1 wherein said antenna array comprises a plurality of paired antenna elements, with each paired antenna elements being dual polarized.

7. The RF device according to claim 6 wherein each paired antenna element comprises a horizontally polarized antenna element and a vertically polarized antenna element.

8. The RF device according to claim 6 wherein said plurality of in-phase and quadrature modules comprises a respective pair of in-phase and quadrature modules downstream from each paired antenna elements for generating a pair of in-phase and quadrature components.

9. The RF device according to claim 1 wherein said threshold detector comprises a constant false alarm rate (CFAR) detector.

10. The RF device according to claim 1 further comprising a transmitter for transmitting dual polarized signals so that the RF device is configured as a radar, with the received dual polarized RF signals being reflected off of an object receiving the transmitted dual polarized signals.

11. A radio frequency (RF) device comprising:
an antenna array for receiving elliptically polarized RF signals;
a plurality of in-phase and quadrature modules coupled to said antenna array for generating a plurality of in-phase and quadrature components;
a homology group matched filter coupled to said plurality of in-phase and quadrature modules for
generating a spectral results matrix based on the plurality of in-phase and quadrature components,
generating a polarization homology group matrix representing a polarized state of an estimated elliptically polarized signal source,
applying at least one estimated source polarization homology parameter to an unmixing equation for generating unmixed elliptically polarized RF signals, the unmixing equation defined by the spectral results matrix and the polarization homology group matrix, and
generating an unmixed elliptically polarized RF signal level based upon the at least one estimated source polarization homology parameter and the unmixed elliptically polarized RF signals; and
a threshold detector coupled to said homology grouped matched filter for determining if the unmixed elliptically polarized RF signal level is above a threshold.

12. The RF device according to claim 11 wherein the at least one estimated source polarization homology parameter comprises a relative amplitude shift between the elliptically polarized RF signals, a relative phase shift between the elliptically polarized RF signals, and azimuth and elevation angles of a direction of the elliptically polarized RF signals.

13. The RF device according to claim 11 wherein applying the at least one estimated source polarization homology parameter to the unmixing equation comprises applying incremented estimated source polarization homology parameters to the unmixing equation, with an unmixed elliptically polarized RF signal level being generated for each incremented parameter.

14. The RF device of claims 11 wherein each element in the polarization homology group matrix comprises at least one of a quanternion number corresponding to an estimated elliptically polarized signal source at an array element, a sum of two complex numbers corresponding to the estimated elliptically polarized signal source, and a Hamiltonian matrix whose norm is invariant in time and corresponds to the total energy-momentum of the desired elliptically polarized signal source.

15. The RF device according to claim 11 wherein said homology group matched filter applies a taper matrix to the unmixing equation for trading mainlobe gain for sidelobe suppression of said antenna array.

16. The RF device according to claim 11 wherein said antenna array comprises a plurality of paired antenna elements, with each paired antenna elements being elliptically polarized; wherein each paired antenna element comprises a horizontally polarized antenna element and a vertically polarized antenna element.

17. The RF device according to claim 16 wherein said plurality of in-phase and quadrature modules comprises a respective pair of in-phase and quadrature modules downstream from each paired antenna elements for generating a pair of in-phase and quadrature components.

18. A method for unmixing dual polarized signals received by a radio frequency (RF) device comprising an antenna array, a plurality of in-phase and quadrature modules coupled to the antenna array, and a homology group matched filter coupled to the plurality of in-phase and quadrature modules, the method comprising:
receiving dual polarized RF signals at the antenna array;
generating a plurality of in-phase and quadrature components using the plurality of in-phase and quadrature modules;
determining in the homology group matched filter an unmixing equation for generating unmixed dual polarized RF signals;
applying at least one estimated source polarization homology parameter to the unmixing equation in the homology group matched filter;
generating in the homology group matched filter an unmixed dual polarized RF signal level based upon the at least one estimated source polarization homology parameter and the unmixed dual polarized RF signals; and
determining if the unmixed dual polarized RF signal level is above a threshold.

19. The method according to claim 18 wherein the dual polarized RF signals comprise elliptically polarized signals.

20. The method according to claim 18 wherein the at least one estimated source polarization homology parameter comprise a relative amplitude shift between the dual polarized RF signals, a relative phase shift between the dual polarized RF signals, and linear phase progressions related to azimuth and elevation angles of a direction of the dual polarized RF signals.

21. The method according to claim 18 wherein applying the at least one estimated source polarization homology parameter to the unmixing equation comprises applying incremented estimated source polarization homology parameters to the unmixing equation, with an unmixed dual polarized RF signal level being generated for each incremented parameter.

22. The method according to claim 18 further comprising applying a taper matrix to the unmixing equation for trading mainlobe gain for sidelobe suppression of the antenna array.

23. The RF device according to claim 18 wherein the antenna array comprises a plurality of paired antenna elements, with each paired antenna elements being dual polarized; wherein each paired antenna element comprises a horizontally polarized antenna element and a vertically polarized antenna element.

24. The RF device according to claim 23 wherein said plurality of in-phase and quadrature modules comprises a respective pair of in-phase and quadrature modules downstream from each paired antenna elements for generating a pair of in-phase and quadrature components.
